(19) United States
(12) Patent Application Publication
(10) Pub. No.: US 2010/0132171 A1
(43) Pub. Date: Jun. 3, 2010

(54) Foldable Casket

(76) Inventor: Xu Jianping, Wuyi (CN)

Correspondence Address: DANIEL S. COOLIDGE;COOLIDGE & GRAVES PLLC, 36 OLD CHANDLERS MILLS ROAD, UNITY, NH, 03743, US

(21) Appl. No.: 12/605,524

(22) Filed: Oct. 26, 2009

(30) Foreign Application Priority Data
Oct. 31, 2008 (CN) 200820167244.9

(51) Int. Cl. A61G 17/013

(52) U.S. Cl. 27/4

(57) ABSTRACT

A folding casket formed by folding two pieces of flat cardboard. Cutting lines and folding lines are provided on said flat cardboard to form a cardboard casket, wherein one piece of flat cardboard is made into a casket body through cutting, folding and interweaving, while the other piece of flat cardboard is made into an upper casket lid through cutting, folding and interweaving, said upper lid is installed onto the casket body by fitting over the latter. The present utility model is formed by folding flat cardboard, leading to low cost and fast incineration; there is no reuse issue, thus effectively eliminating pathogen transmission and meeting requirements for hygiene and epidemic prevention; it can be formed by folding one single piece of cardboard, offering simple and convenient operation; matching holes are provided on both sides of folding lines on the flat cardboard for ventilation; a connection member is further provided between every two holes for reinforcement and at the same time, the hole connection member provides a handle for easy handling.

### TECHNICAL FIELD

The present utility model relates to funeral and internment products, in particular to caskets for holding remains.

### BACKGROUND INFORMATION

Since cremation has been popularized in China, old styled wood caskets have drawbacks in that the cost is high and incineration thereof is slow. As a result, hospital mortuaries and crematoria made improvements by using steel boxes and wood boxes. As these boxes are reused, the cost is reduced. However, there are concerns regarding hygiene and epidemic prevention.

What is needed is an inexpensive casket which can be cremated easily and can be stored and shipped in a compact form.

### SUMMARY

To overcome disadvantages of the above technologies, the present utility model is to provide a folding casket with low cost, fast incineration, no pathogen transmission issues and meeting requirements for hygiene and epidemic prevention.

The technology employed by the present utility model to solve the above technical problems is:

A folding casket formed by folding two pieces of flat cardboard, cutting lines and folding lines are provided on said flat cardboard to form a cardboard casket, wherein one piece of flat cardboard is made into a casket body through cutting, folding and interweaving, while the other piece of flat cardboard is made into an upper casket lid through cutting, folding and interweaving, said upper lid is installed onto the casket body by fitting over the latter.

Said flat cardboard is corrugated paper.

Said folding casket is in a hexagonal form.

Matching holes are provided on both sides of folding lines on the flat cardboard.

A connection member is further provided between said two holes.

The present utility model has the following main benefits: 1. the present utility model is formed by folding two pieces of flat cardboard, leading to low cost and fast incineration; 2. there is no reuse issue, thus effectively eliminating pathogen transmission and meeting requirements for hygiene and epidemic prevention; 3. it can be formed by folding one single piece of cardboard, offering simple and convenient operation; 4. matching holes are provided on both sides of corresponding folding lines on the flat cardboard for ventilation; 5. a connection member is further provided between every two holes for reinforcement and at the same time, the hole connection member provides a handle for easy handling.

### BRIEF DESCRIPTION OF THE DRAWINGS

These and other features and advantages of the present invention will be better understood by reading the following detailed description, taken together with the drawings wherein:

FIG. 1 is a schematic of the structure of the casket body according to the present utility model.

FIG. 2 is a view of the unfolded cardboard to be folded into the casket body according to the present utility model.

FIG. 3 is a schematic of the structure of the upper casket lid according to the present utility model.

FIG. 4 is a view of the unfolded cardboard to be folded into the upper casket lid according to the present utility model.

### DETAILED DESCRIPTION OF THE PREFERRED EMBODIMENTS

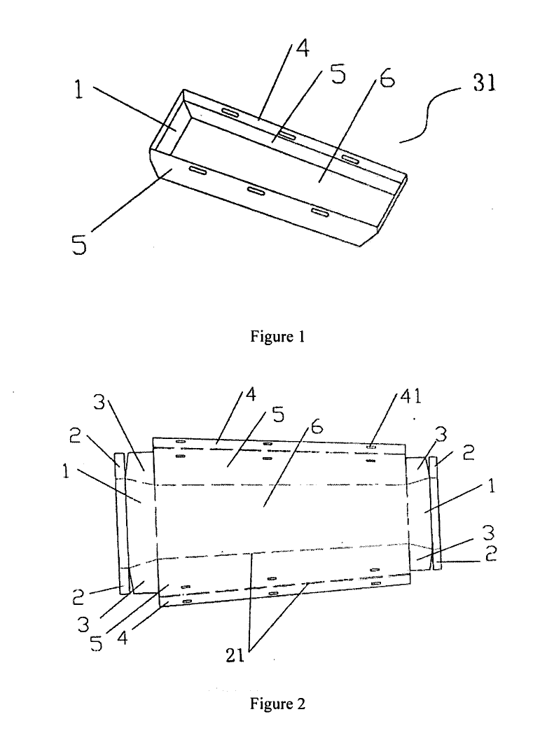

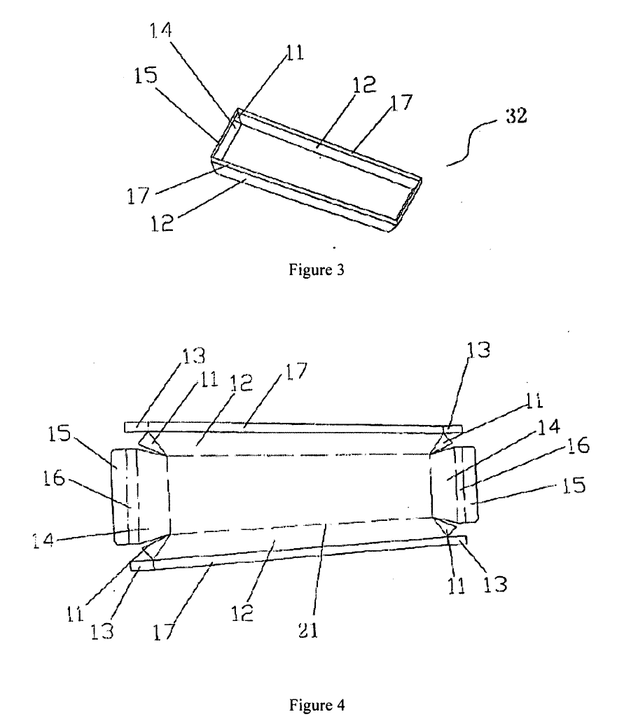

Refer to FIGS. 1-4. A folding casket is formed by folding two pieces of flat cardboard, cutting lines and folding lines 21 are provided on said flat cardboard to form a cardboard casket, wherein one piece of flat cardboard is made into a casket body 31 through cutting, folding and interweaving, while the other piece of flat cardboard is made into an upper casket lid 32 through cutting, folding and interweaving, said upper lid is installed onto the casket body by fitting over the latter. Said flat cardboard is corrugated paper. Said folding casket is in a hexagonal form. Matching holes 41 are provided on both sides of folding lines on the flat cardboard. A connection member can be provided as needed between said two holes.

As shown in FIG. 2, the folding method for the casket body is: fold the face 1 inwardly toward the face 6 (along the line) so that the angle between the face 1 and the face 6 is 90 degree; then fold 2 and 3 inwardly toward 1 (along the line) so that the inward angles between faces 2 and 3 and the face 1 are 90 degree, respectively; also fold 2 inwardly toward 1 (along the line), and then also fold faces 4 and 5 inwardly toward the face 6 (along the line) so that the face 3 leans against the face 5. Then fold the face 4 inwardly to include faces 2 and 3 between faces 4 and 5. All of said “along the line” refer to along a neighboring folding line.

As shown in FIG. 4, the folding method for the upper casket lid is: fold the face 11 inwardly toward the face 12 (along the line) and at the same time, fold the face 13 inwardly toward the face 17 (along the line) so that the face 11 closely abuts against the inwardly folded face 14. And the face 13 rests on the face 16. Fold the face 15 inwardly to include faces 11 and 13 between faces 15 and 16. All of said “along the line” refer to along a neighboring folding line.

Finally, simply fit the upper casket lid over the casket body to complete the installation. To meet clients' needs and to provide a better final form of the product, folding faces next to each other can be glued together; moreover, to enhance the product's sturdiness, the casket body can be lined inside with plates.

Modifications and substitutions by one of ordinary skill in the art are considered to be within the scope of the present invention, which is not to be limited except by the following claims.

The invention claimed is:

1. A folding casket, characterized in that it is formed by folding two pieces of flat cardboard, cutting lines and folding lines are provided on said flat cardboard to form a cardboard casket, wherein one piece of flat cardboard is made into a casket body through cutting, folding and interweaving, while the other piece of flat cardboard is made into an upper casket lid through cutting, folding and interweaving, said upper lid is installed onto the casket body by fitting over the latter.

2. The folding casket as set forth in claim 1, characterized in that said flat cardboard is corrugated paper.

3. The folding casket as set forth in claim 2, characterized in that said folding casket is in a hexagonal form.

4. The folding casket as set forth in claim 3, characterized in that matching holes are provided on both sides of folding lines on the flat cardboard.

5. The folding casket as set forth in claim 4, characterized in that a connection member is further provided between said two holes.
